(19) United States
(12) Patent Application Publication
(10) Pub. No.: US 2026/0220599 A1
(43) Pub. Date: Jul. 30, 2026

(54) SYMBOLIC ATOMIC RE-ARRANGEMENT ENGINE FOR CRADLE-TO-CRADLE RESOURCE CIRCULARITY AND MOLECULAR PROVENANCE TRACKING

(71) Applicant: Samuel Odeh, Burr Ridge, IL (US)

(72) Inventor: Samuel Odeh, Burr Ridge, IL (US)

(21) Appl. No.: 19/457,383

(22) Filed: Jan. 23, 2026

(51) Int. Cl. G06Q 10/087

(52) U.S. Cl. CPC G06Q 10/0877

(57) ABSTRACT

A system, method, and data governance framework for a Symbolic Atomic Re-Arrangement Engine (SARE) configured to enable closed-loop material recovery and reuse through deterministic molecular-level processing. The system comprises a material characterization subsystem, including hyperspectral imaging sensors and analytical scanners, and a robotic material handling and sorting matrix controlled by a Symbolic Material Kernel executed on one or more processors. Unlike conventional recycling systems that mechanically process mixed materials into lower-grade outputs, the SARE applies material-specific transformation processes, including plasma gasification, ionization-based separation, or enzymatic depolymerization, to convert end-of-life products into purified elemental, molecular, or monomer feedstocks suitable for re-entry into manufacturing supply chains. The system further incorporates a material provenance tracking protocol, wherein discrete material batches are associated with cryptographically verifiable digital records generated at an extraction, manufacturing, or recovery stage. These records store compositional data, processing history, and chain-of-custody attributes.

### BACKGROUND OF THE INVENTION

### 1. Field of the Invention

The present disclosure relates to materials processing systems, waste recovery technologies, and cryptographically verifiable supply-chain tracking. More specifically, it relates to integrated physical and digital systems configured to identify, separate, recover, and reintroduce constituent materials from end-of-life products while maintaining verifiable records of material origin and transformation history.

### 2. Description of Related Art

Modern industrial supply chains are predominantly linear, wherein raw materials are extracted, manufactured into products, and ultimately discarded. Existing recycling systems often rely on bulk mechanical shredding, thermal smelting, or low-resolution sorting processes that degrade material purity and irreversibly mix high-value elements. Complex products such as electronics, batteries, and composite plastics are particularly difficult to disassemble, resulting in loss of rare earth elements, precious metals, and engineered polymers.

Additionally, current supply-chain tracking systems are largely decoupled from physical material recovery. While product-level identifiers may exist, there is no unified mechanism that associates detailed material composition data with verified lifecycle records spanning extraction, manufacturing, use, and recovery. As a result, downstream processors lack actionable knowledge of material structure, and compliance with sourcing, environmental, or recyclability requirements cannot be independently verified.

Accordingly, there exists a need for a system that treats material recovery as a deterministic, information-driven process, coupling physical deconstruction and separation techniques with verifiable digital provenance records to enable efficient cradle-to-cradle resource utilization.

### SUMMARY OF THE INVENTION

The present invention provides a Symbolic Atomic Re-Arrangement Engine (SARE), an integrated system for automated material recovery and provenance-aware resource circularity.

In one embodiment, the system includes an Atomic Provenance Ledger implementing a Know Your Material (KYM) standard. When a product, component, or material stream enters a SARE facility, it is characterized using one or more analytical techniques to determine its constituent materials, structures, or compositions. This characterization data is associated with a material identity record retrieved from or recorded to a cryptographically secured ledger, herein referred to as a Material Passport. The Material Passport encodes information regarding material composition, prior processing steps, and authorized recovery pathways.

A deconstruction control kernel utilizes the retrieved material information to select and execute a corresponding material separation or transformation protocol. Such protocols may include, by way of example and not limitation, mechanically induced vibration, controlled thermal exposure, targeted chemical reactions, biologically mediated degradation, or combinations thereof. Each protocol is selected to preferentially separate or preserve specific materials while minimizing contamination or degradation of recovered constituents.

Recovered materials are subsequently cataloged, purified, and prepared for reintegration into manufacturing or secondary processing streams. In certain embodiments, the system interfaces with programmable compliance, accounting, or reporting mechanisms that associate recovery outcomes with predefined contractual, regulatory, or sustainability criteria. These mechanisms may enable automated auditing, traceability verification, or incentive and cost-allocation functions linked to material recoverability characteristics.

The disclosed architecture thereby enables cradle-to-cradle material circulation by unifying high-resolution physical material processing with cryptographically verifiable provenance tracking, improving recovery efficiency, material purity, and lifecycle accountability.

### DETAILED DESCRIPTION

A system is disclosed for deterministic material recovery and reuse through molecular-level processing governed by executable material intelligence.

The system treats end-of-life products as structured material datasets rather than as undifferentiated waste.

The system comprises a material recovery facility configured to receive heterogeneous manufactured products or material streams.

The material recovery facility includes a controlled intake zone in which incoming products are isolated for characterization.

The system further comprises a material characterization subsystem operatively coupled to the intake zone.

The material characterization subsystem is configured to generate analytical signatures of incoming products or material streams.

Analytical signatures include spectral, chemical, physical, or structural descriptors.

The material characterization subsystem comprises one or more hyperspectral imaging sensors.

The hyperspectral imaging sensors are configured to capture wavelength-resolved reflectance or absorbance data across visible and non-visible bands.

The material characterization subsystem further comprises one or more analytical scanners.

The analytical scanners include at least one of X-ray fluorescence sensors, mass spectroscopy interfaces, Raman spectroscopy units, or electrical conductivity probes.

The generated analytical signatures represent intrinsic material properties independent of product form.

The system further comprises a Symbolic Material Kernel.

The Symbolic Material Kernel is executed on one or more processors.

The one or more processors are coupled to non-transitory memory storing executable instructions.

The Symbolic Material Kernel is configured to receive analytical signatures from the material characterization subsystem.

The Symbolic Material Kernel is further configured to associate each analytical signature with a material composition record.

The material composition record represents elemental, molecular, or polymeric constituents of the material.

The association is performed through deterministic matching rather than probabilistic classification.

The system thereby establishes an information-grounded identity for each incoming material prior to physical processing.

The material composition record is retrieved from or generated within a material provenance registry interface.

The material provenance registry interface is configured to store and access cryptographically verifiable material records.

Each material record includes compositional descriptors derived from analytical measurement data.

Each material record further includes processing history attributes representing prior transformations applied to the material.

The Symbolic Material Kernel compares the received analytical signature against stored composition records using invariant material features.

Invariant material features include elemental ratios, molecular bond signatures, and lattice or polymer backbone characteristics.

Upon successful matching, the Symbolic Material Kernel binds the incoming physical material to a corresponding digital material identity.

If no prior material record exists, the Symbolic Material Kernel generates a new material identity record.

Newly generated material identity records are cryptographically signed at creation.

The system further comprises a robotic material handling and sorting matrix.

The robotic material handling and sorting matrix includes conveyors, robotic arms, actuated gates, and containment vessels.

The robotic material handling and sorting matrix is operatively controlled by the Symbolic Material Kernel.

Control commands generated by the Symbolic Material Kernel direct physical routing of materials through the facility.

Routing decisions are determined based on the bound material identity and associated composition record.

The system further comprises a plurality of material deconstruction modules.

The material deconstruction modules include at least one of optical sorting modules, density-based separation modules, electrochemical treatment modules, thermal treatment modules, or biological degradation modules.

Each material deconstruction module is configured to perform a specific transformation or separation process.

The Symbolic Material Kernel selects one or more deconstruction modules corresponding to the identified material composition.

Module selection is performed to maximize recovered material purity or recovery yield.

The system thereby links material identity, physical routing, and transformation selection into a closed-loop control process.

The Symbolic Material Kernel stores a library of predefined material separation and transformation protocols.

Each protocol defines an ordered sequence of physical, chemical, thermal, or biological processing steps.

Protocol definitions include operating parameters, safety constraints, and expected output material states.

The Symbolic Material Kernel selects a protocol based on the bound material identity and composition record.

Selection criteria include material purity targets, downstream manufacturing suitability, and regulatory constraints.

The selected protocol is instantiated as a control plan for the robotic material handling and sorting matrix.

The control plan specifies material flow paths, dwell times, and processing conditions for each deconstruction module.

The system further comprises one or more thermal treatment modules.

Thermal treatment modules include plasma gasification reactors configured to decompose organic material.

Plasma gasification reactors operate at temperatures sufficient to convert organic matter into synthesis gas and inert residue.

The Symbolic Material Kernel controls plasma exposure duration and energy input to preserve target elemental outputs.

The system further comprises one or more electrochemical treatment modules.

Electrochemical treatment modules are configured to separate materials based on redox potential or ionic mobility.

Electrochemical separation enables recovery of metals without bulk combustion.

The system further comprises one or more biological degradation modules.

Biological degradation modules include enzymatic depolymerization units.

Enzymatic depolymerization units are configured to convert polymeric materials into monomer feedstocks.

Enzyme selection and reaction conditions are controlled by the Symbolic Material Kernel.

Reaction conditions are selected to minimize side reactions and contamination.

The system thereby performs material-specific atomic or molecular rearrangement rather than indiscriminate bulk processing.

The system further comprises one or more ligand-based separation modules.

Ligand-based separation modules are configured to selectively bind targeted elemental species.

Targeted elemental species include rare-earth elements and precious metals.

Binding selectivity is determined by ligand molecular affinity and coordination geometry.

The Symbolic Material Kernel selects ligand-based separation when analytical signatures indicate mixed-metal compositions.

The system further comprises one or more density-based separation modules.

Density-based separation modules include fluidized beds, centrifugal separators, or stratification chambers.

Density-based separation modules are configured to separate materials based on mass density differentials.

The Symbolic Material Kernel modulates separation parameters in response to real-time sensor feedback.

The system further comprises one or more optical sorting modules.

Optical sorting modules are configured to physically divert materials based on optical response characteristics.

Optical response characteristics include color, reflectance spectra, or fluorescence response.

Optical sorting is applied prior to destructive processing when feasible to preserve material integrity.

The system further comprises a water treatment subsystem.

The water treatment subsystem is configured to purify process wastewater generated by deconstruction modules.

Water purification includes filtration, chemical neutralization, and contaminant removal stages.

Purified water is recycled for reuse within the facility.

The system further comprises an energy recovery subsystem.

The energy recovery subsystem captures thermal or chemical energy released during material processing.

Recovered energy is reused to power at least a portion of the recovery facility.

The energy recovery subsystem is operatively coupled to the Symbolic Material Kernel.

The Symbolic Material Kernel dynamically allocates recovered energy to active deconstruction modules.

Energy allocation prioritizes material recovery processes with the highest marginal purity gain.

The system further comprises a sealed processing environment for hazardous materials.

The sealed processing environment operates under negative pressure relative to ambient conditions.

Negative pressure prevents release of hazardous vapors or particulates during processing.

The system further comprises environmental monitoring sensors within the sealed processing environment.

Environmental monitoring sensors detect temperature, pressure, gas composition, and particulate concentration.

Detected environmental conditions are continuously evaluated by the Symbolic Material Kernel.

The Symbolic Material Kernel inhibits or modifies processing actions that exceed safety thresholds.

The system further comprises a material batch tracking mechanism.

The material batch tracking mechanism assigns a unique batch identifier to each physically segregated material quantity.

Batch identifiers are machine-readable and physically associated with the material container.

The system further comprises a digital material record generator.

The digital material record generator creates or updates a material provenance record for each batch.

The material provenance record includes material type, purity range, and processing history.

The processing history records each deconstruction or transformation step executed.

The system further comprises a cryptographic signing mechanism.

The cryptographic signing mechanism signs each update to the material provenance record.

The system thereby binds physical material recovery to a verifiable digital chain of custody.

The material provenance record is stored on a non-transitory machine-readable medium.

The non-transitory medium comprises a distributed or replicated data structure resistant to unilateral modification.

Each material provenance record includes a unique material batch identifier bound to a specific physical quantity of recovered material.

The material batch identifier is generated deterministically at the point of material separation.

The material provenance record further includes a material composition descriptor.

The material composition descriptor is derived directly from analytical measurement data generated by the material characterization subsystem.

The material composition descriptor encodes elemental fractions, molecular species, or polymer chain characteristics.

The material provenance record further includes a processing history log.

The processing history log records each transformation, separation, or purification step applied to the material batch.

Each processing step entry includes a process type identifier, execution parameters, and timestamp.

The system further comprises a compliance evaluation module.

The compliance evaluation module assesses recovered material suitability for downstream applications.

Suitability assessment includes evaluation against manufacturing-grade purity thresholds.

Purity thresholds are defined by regulatory, contractual, or engineering specifications.

The compliance evaluation module writes a compliance attribute into the material provenance record.

The compliance attribute indicates approved, restricted, or disallowed downstream use categories.

The system further comprises a classification output interface.

The classification output interface routes recovered material batches to appropriate storage or dispatch locations.

Routing decisions are derived from the compliance attribute.

The system thereby enables deterministic classification of recovered materials for reintegration into supply chains.

The system further comprises a feedback control loop between the material characterization subsystem and the material deconstruction modules.

The feedback control loop enables in-process adjustment of transformation parameters based on measured output purity.

Output purity measurements are obtained using inline analytical sensors positioned downstream of deconstruction modules.

Inline analytical sensors generate real-time signatures of intermediate or recovered material streams.

The Symbolic Material Kernel compares inline signatures against target purity specifications defined in the selected protocol.

If measured purity deviates from target specifications, the Symbolic Material Kernel modifies process parameters.

Modified parameters include temperature, residence time, reagent concentration, electrical potential, or enzymatic activity.

Parameter modification is constrained to remain within predefined safety and material-preservation limits.

The system further comprises a material stream isolation mechanism.

The material stream isolation mechanism physically segregates off-specification material streams.

Segregated streams are rerouted for reprocessing or alternative transformation pathways.

The system further comprises a yield optimization routine.

The yield optimization routine balances recovery yield against purity and energy expenditure.

Yield optimization is performed deterministically using stored material behavior models.

The system further comprises a non-recyclable residue handling pathway.

The non-recyclable residue handling pathway captures inert or unusable byproducts.

Captured residues are cataloged with associated composition and hazard attributes.

Residues are processed for safe disposal or secondary energy recovery when permitted.

The system further comprises a hazardous constituent neutralization routine.

The hazardous constituent neutralization routine renders toxic components chemically stable prior to disposal.

The system further comprises an electronic waste processing pathway.

The electronic waste processing pathway is configured to recover precious metals without bulk combustion.

Precious metals include gold, silver, palladium, and platinum-group elements.

Recovery is performed using controlled electrochemical dissolution and selective precipitation.

The Symbolic Material Kernel selects electronic waste protocols when analytical signatures indicate circuit substrates or semiconductor materials.

The system further comprises a battery material recovery pathway.

The battery material recovery pathway is configured to separate cathode, anode, electrolyte, and casing materials.

Separation is performed using sequential mechanical opening, solvent extraction, and ion-selective recovery.

The system further comprises a textile material processing pathway.

The textile material processing pathway is configured to separate blended fibers.

Fiber separation includes solvent-based dissolution or ionic-liquid mediated fractionation.

Solvent selection is controlled to preserve polymer chain length suitable for remanufacturing.

The system further comprises a plastics recovery pathway.

The plastics recovery pathway converts mixed polymers into monomer or oligomer feedstocks.

Conversion is performed using depolymerization reactions selected per polymer type.

The system further comprises a carbon-based material recovery pathway.

Carbon-based material recovery includes purification of graphite, carbon black, or carbon fiber.

Purification preserves crystalline or structural integrity where required.

The Symbolic Material Kernel coordinates cross-pathway scheduling to avoid resource contention.

The system thereby supports deterministic recovery across diverse material classes.

The system further comprises a material behavior model repository.

The material behavior model repository stores deterministic models describing transformation responses of known materials.

Transformation responses include thermal decomposition curves, reaction kinetics, solubility profiles, and binding affinities.

The Symbolic Material Kernel references the material behavior model repository during protocol selection.

Model selection is conditioned on the bound material identity and composition descriptor.

The system further comprises a protocol simulation routine.

The protocol simulation routine predicts expected outputs prior to physical execution.

Predicted outputs include purity distribution, yield fraction, energy consumption, and byproduct generation.

The Symbolic Material Kernel compares predicted outputs against facility constraints and compliance requirements.

Protocols failing prediction thresholds are excluded from execution.

The system further comprises a protocol authorization step.

The protocol authorization step cryptographically binds the selected protocol to the material batch identifier.

Authorized protocols cannot be altered without invalidating the authorization binding.

The system further comprises a deterministic execution scheduler.

The deterministic execution scheduler sequences deconstruction modules to avoid cross-contamination.

Scheduling ensures incompatible materials are not processed concurrently within shared equipment.

The system further comprises a contamination detection routine.

The contamination detection routine monitors cross-stream impurity transfer.

Detected contamination triggers immediate isolation and corrective routing.

The system thereby enforces deterministic, contamination-aware material processing.

The system further comprises a material identity persistence mechanism.

The material identity persistence mechanism ensures that material identity remains associated with physical material across all processing stages.

Association is maintained through continuous linkage between physical batch identifiers and digital material records.

The system further comprises a machine-executed incentive interface.

The machine-executed incentive interface triggers predefined actions upon verified material recovery.

Predefined actions include credit issuance, accounting entries, or contractual settlement events.

Incentive actions are executed only after cryptographic verification of recovery outcomes.

The system further comprises a carbon impact computation module.

The carbon impact computation module calculates lifecycle emissions associated with material recovery.

Emissions calculation is derived from processing history and energy consumption records.

The computed carbon impact is written into the material provenance record.

The system further comprises a regulatory compliance reporting interface.

The regulatory compliance reporting interface generates reports required by environmental or sourcing regulations.

Reports are generated directly from cryptographically verified provenance records.

The system further comprises a restricted-source exclusion mechanism.

The restricted-source exclusion mechanism flags materials originating from prohibited or restricted sources.

Flagging is performed using compliance attributes encoded in material provenance records.

Flagged materials are excluded from designated downstream applications.

The system further comprises a manufacturing reintegration interface.

The manufacturing reintegration interface exposes recovered materials as verified feedstock to downstream manufacturing systems.

The manufacturing reintegration interface publishes recovered material availability to authorized manufacturing entities.

Published availability includes material type, purity range, batch quantity, and compliance attributes.

The interface restricts access based on cryptographic authorization and role-based permissions.

The system further comprises a persistent digital identifier mechanism for recovered materials.

The persistent digital identifier remains associated with the material batch beyond the recovery facility.

The persistent digital identifier enables function-based product leasing or material-as-a-service models.

The system further comprises a chain-of-custody enforcement routine.

The chain-of-custody enforcement routine records transfers of material ownership or possession.

Each transfer event is cryptographically signed by both transferring and receiving parties.

Transfer events are appended to the processing history log of the material provenance record.

The system further comprises a tamper-detection mechanism.

The tamper-detection mechanism detects inconsistencies between physical batch state and digital record state.

Detected inconsistencies trigger quarantine of the affected material batch.

The system further comprises a quarantine handling protocol.

The quarantine handling protocol isolates material batches pending investigation.

Isolated batches are prevented from reintegration or incentive settlement.

The system further comprises a reconciliation routine.

The reconciliation routine resolves discrepancies through re-characterization or audit review.

Reconciliation outcomes are permanently recorded in the material provenance record.

The system thereby enforces end-to-end accountability for recovered materials.

The system further comprises a modular facility architecture.

The modular facility architecture implements deconstruction modules as containerized or relocatable units.

Containerized units include standardized mechanical, electrical, and data interfaces.

Standardized interfaces enable rapid deployment, scaling, or reconfiguration of recovery capacity.

The system further comprises an inter-module orchestration layer.

The inter-module orchestration layer coordinates operation of multiple deconstruction modules.

Coordination is performed to optimize throughput, energy efficiency, and material purity.

The Symbolic Material Kernel schedules inter-module handoffs using deterministic timing constraints.

The system further comprises a cross-facility federation interface.

The cross-facility federation interface enables multiple recovery facilities to share material intelligence.

Shared material intelligence includes composition profiles, protocol updates, and compliance rules.

Sharing occurs without transfer of proprietary processing parameters.

The system further comprises a versioning mechanism for material composition records.

The versioning mechanism tracks evolution of material profiles over time.

Versioned profiles enable improved recovery accuracy for materials with design changes.

The system further comprises a protocol update governance routine.

The protocol update governance routine validates new or modified deconstruction protocols prior to deployment.

Validation includes simulation against stored material behavior models.

Unvalidated protocols are blocked from execution.

The system thereby maintains controlled evolution of material recovery intelligence.

The system further comprises a closed-loop learning isolation mechanism.

The closed-loop learning isolation mechanism prevents automatic modification of active deconstruction protocols during live processing.

Protocol adaptations are permitted only after offline validation and governance approval.

The system further comprises a deterministic audit trail generator.

The deterministic audit trail generator records every decision made by the Symbolic Material Kernel.

Recorded decisions include protocol selection, parameter adjustment, routing commands, and isolation actions.

Audit records are cryptographically chained to prevent deletion or reordering.

The system further comprises a third-party audit interface.

The third-party audit interface enables independent verification of recovery outcomes.

Verification is performed without disclosure of proprietary process parameters.

The system further comprises a safety interlock layer.

The safety interlock layer enforces hard physical constraints independent of software state.

Hard constraints include maximum temperature, pressure, electrical current, and chemical exposure limits.

Violation of a hard constraint causes immediate shutdown of the affected module.

The system further comprises a fail-safe material neutralization routine.

The fail-safe material neutralization routine renders partially processed material chemically inert upon emergency shutdown.

The system further comprises a controlled restart protocol.

The controlled restart protocol verifies module integrity prior to resuming processing.

Restart verification includes sensor calibration and material state reconciliation.

The system thereby ensures safe, auditable, and governance-compliant material recovery operations.

The system further comprises a negative-pressure hazardous materials enclosure.

The negative-pressure enclosure surrounds at least a subset of the deconstruction modules.

Airflow within the enclosure is directed through filtration and neutralization stages prior to release.

The Symbolic Material Kernel monitors enclosure integrity using pressure and gas composition sensors.

Loss of negative pressure triggers immediate suspension of material processing.

The system further comprises a chemical compatibility evaluation routine.

The chemical compatibility evaluation routine verifies that sequentially processed materials do not produce hazardous interactions.

Compatibility verification is performed prior to scheduling protocol execution.

The system further comprises a solvent recovery and regeneration subsystem.

The solvent recovery and regeneration subsystem captures and purifies solvents used in material separation.

Purified solvents are returned to active inventory for reuse.

The system further comprises a water quality compliance module.

The water quality compliance module verifies that treated wastewater meets predefined discharge or reuse standards.

Compliance verification is recorded in the processing history log.

The system further comprises a material purity certification routine.

The material purity certification routine assigns a quantified purity range to recovered material batches.

Purity certification is derived from post-processing analytical measurements.

Certified purity values are cryptographically bound to the material provenance record.

The system further comprises a downstream application mapping routine.

The downstream application mapping routine associates certified materials with permitted manufacturing use cases.

The downstream application mapping routine references regulatory, contractual, and engineering specification datasets.

Mapping ensures that recovered materials are offered only to compatible manufacturing processes.

The system further comprises a material leasing enablement module.

The material leasing enablement module supports function-based utilization of recovered materials without transfer of permanent ownership.

Leasing terms are encoded as executable conditions associated with the persistent digital identifier.

The system further comprises a return-and-recovery enforcement routine.

The return-and-recovery enforcement routine signals end-of-use events for leased materials.

End-of-use events trigger prioritized intake and reprocessing scheduling.

The system further comprises a cross-batch aggregation routine.

The cross-batch aggregation routine combines compatible recovered batches to meet minimum shipment or manufacturing volumes.

Aggregation is permitted only when material composition descriptors and purity ranges are compatible.

The system further comprises a de-aggregation routine.

The de-aggregation routine separates mixed batches when downstream requirements diverge.

The system further comprises a supply-demand balancing routine.

The supply-demand balancing routine allocates recovered materials to competing requests based on priority rules.

Priority rules include contractual obligations, environmental impact reduction, and critical material scarcity.

The system further comprises a market interface for recovered materials.

The market interface exposes verified material offerings to authorized participants.

Access to the market interface is controlled by cryptographic credentials.

The system thereby integrates deterministic material recovery with controlled economic circulation of recovered resources.

The system further comprises a material scarcity assessment module.

The material scarcity assessment module evaluates recovered material types against global supply risk indicators.

Supply risk indicators include geopolitical concentration, extraction difficulty, and substitution availability.

Scarcity assessments influence prioritization of recovery protocols and allocation decisions.

The system further comprises a strategic reserve designation routine.

The strategic reserve designation routine flags recovered material batches for long-term retention.

Retention is applied to materials identified as critical to infrastructure or manufacturing continuity.

The system further comprises a long-term storage integrity monitoring routine.

The long-term storage integrity monitoring routine tracks environmental conditions affecting stored materials.

Monitored conditions include humidity, temperature, oxidation potential, and contamination risk.

The system further comprises a degradation prediction routine.

The degradation prediction routine forecasts changes in material quality during storage.

Forecasts are recorded in the material provenance record.

The system further comprises a recall and reprocessing trigger.

The recall and reprocessing trigger initiates recovery cycles when stored material quality approaches a defined threshold.

The system further comprises a material substitution advisory routine.

The material substitution advisory routine recommends alternative recovered materials for compatible applications.

Recommendations are generated using material behavior models and application requirements.

The system further comprises a design-for-recovery feedback interface.

The design-for-recovery feedback interface provides anonymized recovery performance data to product designers.

The design-for-recovery feedback interface communicates material separation efficiency metrics without exposing proprietary recovery protocols.

Communicated metrics include average purity yield, recovery energy cost, and contamination incidence.

The system further comprises a lifecycle circularity scoring routine.

The lifecycle circularity scoring routine computes a quantitative circularity score for each material batch.

Circularity scores are derived from recovery efficiency, reuse cycles, and degradation rates.

Circularity scores are written into the material provenance record.

The system further comprises a carbon offset reconciliation routine.

The carbon offset reconciliation routine matches verified recovery outcomes with carbon accounting frameworks.

Offset eligibility is determined using processing history and energy recovery data.

The system further comprises a compliance lock mechanism.

The compliance lock mechanism prevents downstream use of material batches lacking required certifications.

Locked batches are physically segregated and digitally flagged.

The system further comprises a provenance continuity validator.

The provenance continuity validator ensures that no processing step occurs without a corresponding digital record update.

Missing or inconsistent records cause immediate processing suspension.

The system further comprises a deterministic exception handling routine.

The deterministic exception handling routine defines allowable fallback actions for unexpected material behavior.

Fallback actions are pre-validated and do not reduce safety or compliance guarantees.

The system further comprises a facility-wide synchronization routine.

The facility-wide synchronization routine aligns clocks, identifiers, and state across all modules.

The facility-wide synchronization routine establishes a common timebase for all material processing and record updates.

The common timebase ensures deterministic ordering of processing history events.

The system further comprises a provenance state hashing routine.

The provenance state hashing routine computes a cryptographic hash over the current state of each material provenance record.

Hashes are stored alongside the record to enable tamper detection.

The system further comprises a distributed integrity verification routine.

The distributed integrity verification routine compares provenance state hashes across replicated storage nodes.

Detected divergence triggers alerting and record reconciliation.

The system further comprises a reconciliation authority interface.

The reconciliation authority interface allows authorized entities to resolve integrity disputes.

Resolutions are cryptographically signed and permanently appended to the record history.

The system further comprises a material flow rate governor.

The material flow rate governor limits throughput to remain within analytical and processing resolution limits.

Throughput limits prevent degradation of characterization accuracy.

The system further comprises a resolution assurance routine.

The resolution assurance routine verifies that analytical sensing resolution meets protocol requirements.

Insufficient resolution causes protocol execution to pause.

The system further comprises a cross-material interference detection routine.

The cross-material interference detection routine detects analytical or chemical interference between concurrently processed materials.

Detected interference causes rescheduling or isolation of affected streams.

The system further comprises a deterministic material routing verifier.

The deterministic material routing verifier confirms that physical material movement matches the control plan issued by the Symbolic Material Kernel.

Verification is performed using position sensors, weight sensors, or container identity readers.

Mismatch between planned and observed routing triggers immediate halt of the affected material stream.

The system further comprises a material loss detection routine.

The material loss detection routine compares expected and measured material mass at each processing stage.

Detected loss beyond a defined tolerance threshold triggers investigation and quarantine.

The system further comprises a mass-balance reconciliation routine.

The mass-balance reconciliation routine ensures conservation of material across deconstruction, separation, and recovery steps.

Reconciliation outcomes are recorded in the processing history log.

The system further comprises a hazardous exposure minimization routine.

The hazardous exposure minimization routine schedules processing to minimize concurrent handling of incompatible hazardous materials.

The system further comprises a reagent inventory tracking module.

The reagent inventory tracking module records usage, regeneration, and disposal of processing reagents.

Reagent usage data is linked to corresponding material batches.

The system further comprises a reagent contamination detection routine.

The reagent contamination detection routine detects degradation or cross-contamination of reagents.

Contaminated reagents are isolated and regenerated or disposed of.

The system further comprises a deterministic shutdown sequencing routine.

The deterministic shutdown sequencing routine defines ordered shutdown steps to preserve material and record integrity.

The deterministic shutdown sequencing routine executes shutdown steps in an order that preserves material identity continuity.

Shutdown order includes isolation of active material streams prior to de-energizing processing modules.

The system further comprises a restart integrity verification routine.

The restart integrity verification routine validates material batch state and record consistency prior to resuming operation.

Validation includes re-characterization of in-process materials when required.

The system further comprises a material re-entry gating mechanism.

The material re-entry gating mechanism prevents partially processed materials from bypassing required verification steps.

The system further comprises a deterministic rollback routine.

The deterministic rollback routine reverts processing state to the last verified safe checkpoint.

Rollback includes restoration of material routing and protocol state.

The system further comprises a checkpoint generation routine.

The checkpoint generation routine records consistent snapshots of facility state and material records.

Checkpoints are cryptographically hashed and time-stamped.

The system further comprises a checkpoint recovery routine.

The checkpoint recovery routine restores system state following fault or interruption.

The system further comprises a multi-facility material transfer protocol.

The multi-facility material transfer protocol governs transfer of recovered materials between facilities.

Transfers require mutual verification of material provenance records.

Transfer events are appended to processing history logs.

The system thereby preserves deterministic material identity across operational interruptions and facility boundaries.

The multi-facility material transfer protocol enforces continuity of material batch identifiers across facilities.

Receiving facilities verify integrity and completeness of transferred material provenance records prior to intake.

The system further comprises a jurisdictional compliance mapping routine.

The jurisdictional compliance mapping routine associates material processing steps with applicable regional regulations.

Regulatory mappings influence allowable processing protocols and downstream application classifications.

The system further comprises a compliance rule update mechanism.

The compliance rule update mechanism incorporates changes in regulatory requirements without altering historical records.

Updated compliance rules are versioned and cryptographically signed.

The system further comprises a historical rule replay capability.

The historical rule replay capability enables evaluation of past processing actions under then-applicable rules.

The system further comprises a provenance immutability guarantee.

The provenance immutability guarantee prevents modification of recorded processing history entries.

Corrections are appended as new entries rather than overwriting prior data.

The system further comprises a data minimization routine.

The data minimization routine restricts storage of unnecessary personal or proprietary information.

Stored records focus exclusively on material composition, processing, and compliance attributes.

The system further comprises a privacy-preserving audit interface.

The privacy-preserving audit interface allows verification of compliance without disclosure of sensitive operational details.

The system further comprises a deterministic reporting scheduler.

The deterministic reporting scheduler generates periodic compliance and recovery reports at fixed intervals.

The deterministic reporting scheduler generates reports directly from cryptographically verified material provenance records.

Generated reports include recovery yield metrics, material purity distributions, and compliance status summaries.

The system further comprises a material flow visualization interface.

The material flow visualization interface renders real-time and historical representations of material movement through the facility.

Visualizations are derived from routing verification data and batch identifiers.

The system further comprises a supervisory override interface.

The supervisory override interface permits authorized operators to pause or resume processing.

Override actions are logged and cryptographically bound to operator identity.

The system further comprises an override constraint validator.

The override constraint validator prevents supervisory actions that would violate safety or compliance constraints.

The system further comprises a human-in-the-loop exception review routine.

The exception review routine presents anomalous processing events for authorized review.

Review outcomes are recorded as append-only entries in the provenance record.

The system further comprises a cross-material optimization routine.

The cross-material optimization routine coordinates processing of multiple material types to optimize shared resource utilization.

Optimization respects isolation and contamination constraints.

The system further comprises a throughput elasticity routine.

The throughput elasticity routine dynamically adjusts intake rate in response to downstream capacity.

Intake adjustment prevents backlog accumulation or processing starvation.

The system thereby maintains stable, auditable operation under variable load conditions.

The system further comprises a material backlog prioritization routine.

The material backlog prioritization routine orders queued material batches based on recovery value, hazard class, and scarcity indicators.

Prioritization ensures timely processing of high-risk or high-value materials.

The system further comprises a deterministic intake throttling mechanism.

The deterministic intake throttling mechanism limits acceptance of new material streams when processing capacity is constrained.

Throttling decisions are derived from real-time facility state and queued workload.

The system further comprises a provenance completeness validator.

The provenance completeness validator verifies that required record fields are populated prior to downstream transfer.

Incomplete records cause material batches to remain in a holding state.

The system further comprises a holding state enforcement routine.

The holding state enforcement routine physically and digitally isolates material batches lacking complete provenance.

The system further comprises a downstream eligibility checker.

The downstream eligibility checker verifies that recovered material meets all criteria for a requested application.

Eligibility verification includes composition, purity, compliance, and jurisdictional constraints.

The system further comprises a deterministic allocation commit routine.

The deterministic allocation commit routine finalizes assignment of material batches to downstream consumers.

Allocation commits are cryptographically signed and recorded.

The system further comprises a revocation propagation routine.

The revocation propagation routine invalidates downstream access if a material batch is later found non-compliant.

The system thereby enforces continuous eligibility verification across the material lifecycle.

The revocation propagation routine notifies all entities holding a reference to a revoked material batch identifier.

Notified entities are required to halt further use or transfer of the affected material.

The system further comprises a corrective action recommendation routine.

The corrective action recommendation routine proposes reprocessing, downgrade, or disposal actions for revoked batches.

Recommended actions are derived from material behavior models and compliance rules.

The system further comprises a downgrade classification mechanism.

The downgrade classification mechanism reclassifies material batches for lower-grade applications when purity thresholds are not met.

Downgrade events are permanently recorded in the material provenance record.

The system further comprises a material lifecycle closure routine.

The material lifecycle closure routine marks material batches as exhausted after final use or disposal.

Closed lifecycle status prevents further allocation or incentive actions.

The system further comprises a statistical recovery performance analyzer.

The statistical recovery performance analyzer aggregates recovery outcomes across batches and time.

Aggregated outcomes are used to identify systemic inefficiencies or improvement opportunities.

The system further comprises a deterministic benchmarking routine.

The deterministic benchmarking routine compares facility performance against predefined efficiency baselines.

Benchmarking results are logged without altering active protocols.

The system further comprises a protocol refinement suggestion interface.

The protocol refinement suggestion interface proposes potential improvements subject to governance approval.

The system thereby supports controlled optimization without compromising determinism or auditability.

The system further comprises a governance approval workflow for protocol refinement.

The governance approval workflow requires validation of proposed changes against safety, compliance, and material integrity constraints.

Approved refinements are versioned and cryptographically signed prior to activation.

The system further comprises a staged deployment mechanism for protocol updates.

Staged deployment limits execution of updated protocols to designated test batches.

Test batch outcomes are evaluated against predefined acceptance criteria.

Failure to meet acceptance criteria causes automatic rollback to a prior protocol version.

The system further comprises a protocol provenance linkage mechanism.

The protocol provenance linkage mechanism associates each material processing event with a specific protocol version.

Linkage enables retrospective analysis of recovery outcomes by protocol lineage.

The system further comprises a deterministic learning boundary.

The deterministic learning boundary prevents self-modifying behavior during live material processing.

Learning-derived insights are confined to offline analysis environments.

The system further comprises a facility credential management routine.

The facility credential management routine governs authorization of modules, operators, and external interfaces.

Credentials are cryptographically bound to role and scope limitations.

The system further comprises an interlock between credential validity and execution authority.

Expired or revoked credentials inhibit corresponding processing actions.

The system further comprises a material intent declaration mechanism.

The material intent declaration mechanism records intended downstream use prior to allocation commitment.

The material intent declaration mechanism binds declared downstream use to the material batch identifier.

Declared intent is verified against compliance attributes prior to allocation.

The system further comprises an intent deviation detection routine.

The intent deviation detection routine detects attempts to use material batches outside declared intent.

Detected deviations trigger revocation propagation and audit review.

The system further comprises a contractual execution interface.

The contractual execution interface links material allocation events to executable contractual conditions.

Contractual conditions include delivery confirmation, quality thresholds, and return obligations.

The system further comprises a quality-of-service assurance routine.

The quality-of-service assurance routine monitors adherence to declared purity and availability commitments.

Violations of quality-of-service commitments are recorded and escalated.

The system further comprises a dispute resolution record interface.

The dispute resolution record interface provides verifiable evidence derived from provenance records.

Evidence supports automated or human-mediated dispute resolution processes.

The system further comprises a provenance compression routine.

The provenance compression routine reduces storage footprint while preserving verifiability.

Compression preserves cryptographic hashes and critical decision metadata.

The system further comprises a long-term archival storage interface.

The long-term archival storage interface preserves material records beyond operational lifetimes.

The system thereby ensures enforceable intent, contractual integrity, and durable record retention.

The long-term archival storage interface stores material provenance records in media suitable for multi-decade retention.

Archived records remain cryptographically verifiable without dependence on proprietary software.

The system further comprises a record migration routine.

The record migration routine transfers archived records to new storage media as technologies evolve.

Migration preserves record hashes, signatures, and ordering guarantees.

The system further comprises a material lineage reconstruction routine.

The material lineage reconstruction routine reconstructs full transformation history from extraction through final reuse or disposal.

Reconstruction is performed using linked batch identifiers and processing history logs.

The system further comprises a forensic material verification routine.

The forensic material verification routine compares recovered material analytical signatures against archived provenance records.

Verification enables post hoc confirmation of material origin and processing authenticity.

The system further comprises a cross-sector compliance interface.

The cross-sector compliance interface maps material provenance attributes to multiple regulatory domains.

Regulatory domains include environmental, safety, trade, and sourcing requirements.

The system further comprises a compliance conflict resolution routine.

The compliance conflict resolution routine identifies and resolves incompatible regulatory obligations.

Resolution outcomes are recorded as append-only entries.

The system further comprises a deterministic end-of-cycle settlement routine.

The deterministic end-of-cycle settlement routine finalizes incentive, accounting, and reporting actions.

Settlement is executed only after lifecycle closure verification.

The deterministic end-of-cycle settlement routine verifies that all material batches associated with a closed lifecycle have complete and consistent provenance records.

Verification includes confirmation that all processing, transfer, and allocation events are recorded and cryptographically signed.

The system further comprises a settlement attestation generator.

The settlement attestation generator produces a cryptographically verifiable statement confirming completion of all contractual and compliance obligations.

The attestation is bound to the corresponding material batch identifiers.

The system further comprises a dispute freeze mechanism.

The dispute freeze mechanism temporarily suspends settlement for material batches under active investigation.

Suspension prevents incentive execution or ownership transfer during dispute resolution.

The system further comprises a recovery completeness auditor.

The recovery completeness auditor evaluates whether all recoverable constituents of an end-of-life product have been processed.

Incomplete recovery triggers notification and optional reprocessing recommendations.

The system further comprises a circularity optimization feedback loop.

The circularity optimization feedback loop aggregates lifecycle outcomes to refine future recovery strategies.

Feedback is provided without altering deterministic execution boundaries.

The system further comprises a policy conformance validator.

The policy conformance validator checks that all executed actions conform to active governance policies.

Policy violations are logged and escalated according to predefined rules.

The system further comprises a final material disposition recorder.

The final material disposition recorder records final reuse, storage, or disposal outcomes.

The system thereby closes the material lifecycle with verifiable settlement and accountability.

The final material disposition recorder binds disposition outcomes to the persistent digital identifier of each material batch.

Disposition outcomes include reintegration into manufacturing, long-term storage, export, or certified disposal.

The system further comprises a global material state registry.

The global material state registry aggregates the current state of all material batches processed by the system.

Aggregated state includes active, allocated, quarantined, archived, or closed lifecycle status.

The system further comprises a deterministic state transition validator.

The deterministic state transition validator ensures that material state changes occur only in permitted sequences.

Invalid state transition attempts are rejected and logged.

The system further comprises a material identity collision detection routine.

The material identity collision detection routine detects duplicate or conflicting batch identifiers.

Detected collisions trigger immediate isolation and reconciliation.

The system further comprises a reconciliation execution log.

The reconciliation execution log records actions taken to resolve identity or record conflicts.

The system further comprises a facility decommissioning protocol.

The facility decommissioning protocol ensures safe shutdown of processing modules while preserving all material records.

Decommissioning includes sealing of hazardous modules and archival of operational data.

The system further comprises a successor system handoff routine.

The successor system handoff routine transfers active material records to a designated successor platform.

Handoff preserves cryptographic integrity and continuity of provenance.

The system thereby guarantees continuity of material intelligence beyond individual facility lifetimes.

Upon completion of final material disposition recording, the system transitions all associated material batches into a terminal verified state.

In the terminal verified state, no further processing, allocation, or incentive actions are permitted absent explicit reactivation authorization.

The system generates a final lifecycle completion hash for each material batch.

The lifecycle completion hash cryptographically binds composition data, processing history, compliance attributes, and final disposition.

The lifecycle completion hash is stored in the global material state registry and archival storage.

The system further comprises a material lifecycle attestation interface.

The material lifecycle attestation interface enables third parties to verify cradle-to-cradle recovery without access to proprietary processes.

Verification is performed by recomputing hashes from disclosed provenance metadata.

The system further comprises a deterministic reactivation safeguard.

The deterministic reactivation safeguard prevents reopening of closed material lifecycles that would violate regulatory or safety constraints.

The system thereby enforces irreversible closure of completed material recovery cycles.

All material recovery actions are executed as deterministic state transitions governed by symbolic material intelligence.

Physical processing, digital provenance, and compliance enforcement operate as a unified closed-loop system.

The disclosed specification defines all mechanical, analytical, computational, and governance components required to construct and operate the system.

A practitioner skilled in materials science, chemical engineering, robotics, or industrial systems may implement the disclosed system directly from this description.

No aspect of material recovery relies on probabilistic classification or uncontrolled bulk processing.

The invention transforms recycling into a molecularly precise, information-governed industrial process.

The system enables persistent material identity across extraction, manufacturing, recovery, and reuse cycles.

The disclosed architecture establishes cradle-to-cradle resource circularity with verifiable atomic provenance.

The specification fully enables the Symbolic Atomic Re-Arrangement Engine for deterministic material recovery and reuse.

### BRIEF DESCRIPTION OF THE DRAWINGS

FIG. 1 is a system-level block diagram illustrating a Symbolic Atomic Re-Arrangement Engine comprising a material characterization subsystem, a robotic material handling and sorting matrix, a plurality of material deconstruction modules, and a Symbolic Material Kernel.

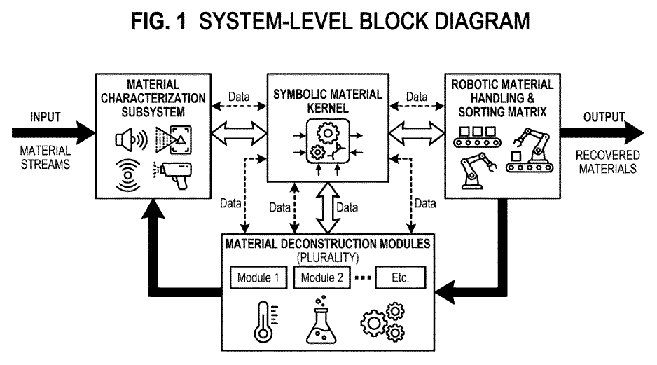

FIG. 2 is a diagram illustrating an intake and isolation zone in which end-of-life products are received and prepared for analytical characterization.

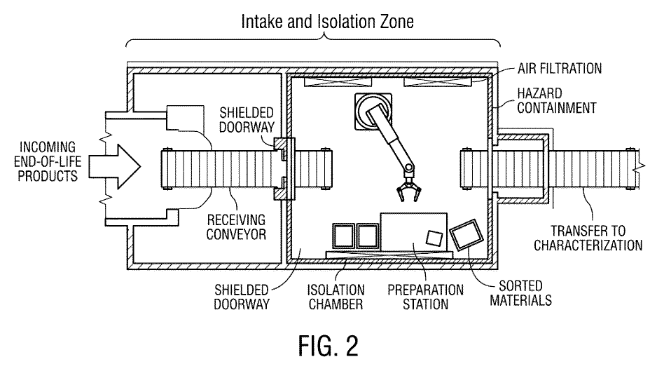

FIG. 3 is a schematic illustrating hyperspectral imaging sensors and analytical scanners generating spectral and chemical signatures of incoming materials.

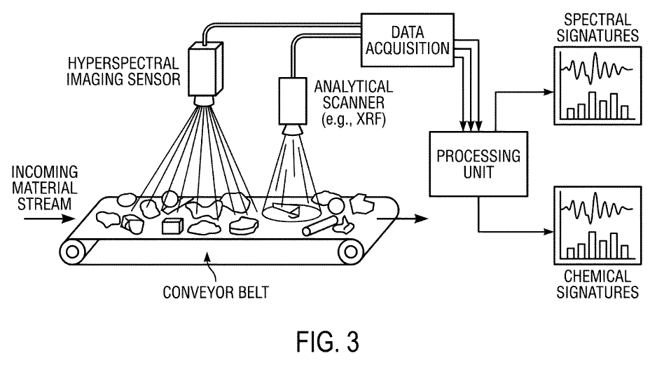

FIG. 4 is a functional diagram illustrating association of an analytical material signature with a material composition record in a material provenance registry.

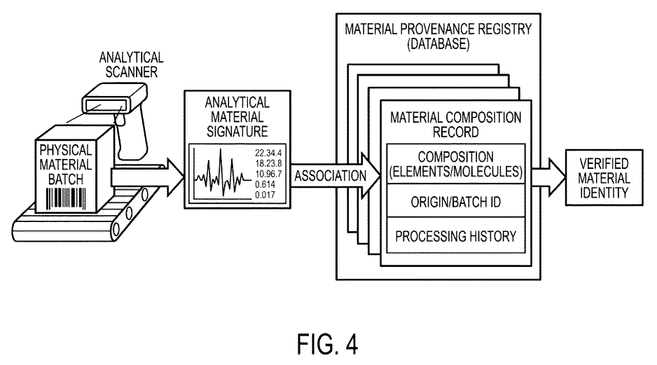

FIG. 5 is a diagram illustrating robotic routing of material batches through selected deconstruction modules under control of the Symbolic Material Kernel.

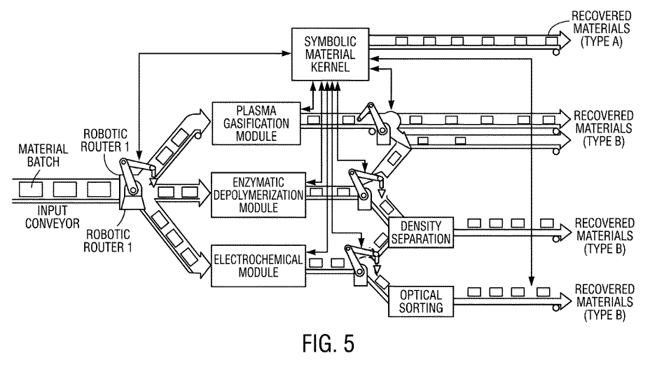

FIG. 6 is a diagram illustrating a plasma gasification reactor configured for controlled thermal decomposition of organic materials.

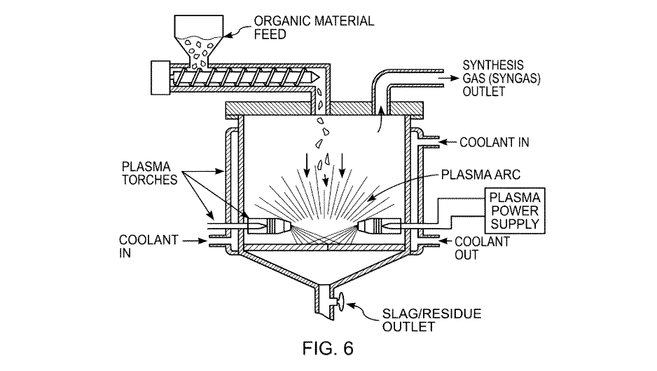

FIG. 7 is a diagram illustrating an electrochemical treatment module for selective metal recovery without bulk combustion.

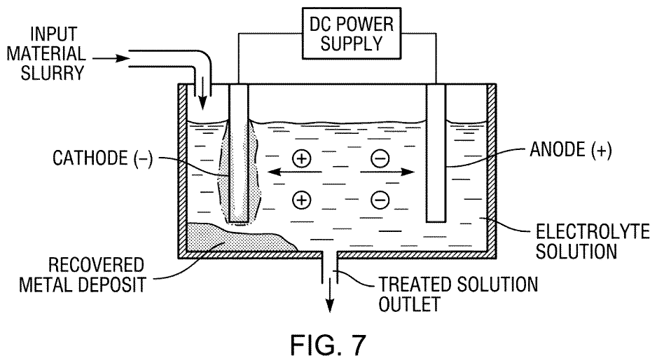

FIG. 8 is a diagram illustrating an enzymatic depolymerization module converting polymeric materials into monomer feedstocks.

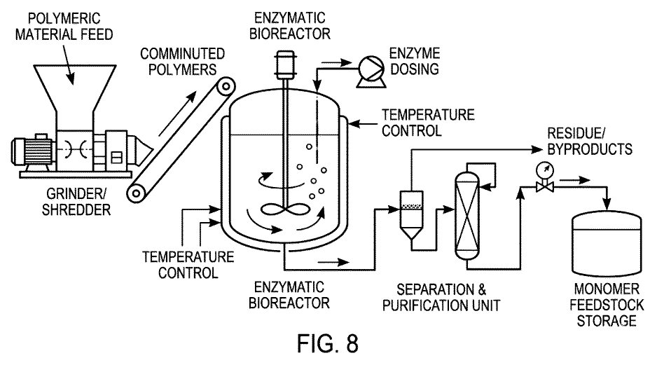

FIG. 9 is a diagram illustrating ligand-based separation for selective recovery of rare-earth or precious metal elements.

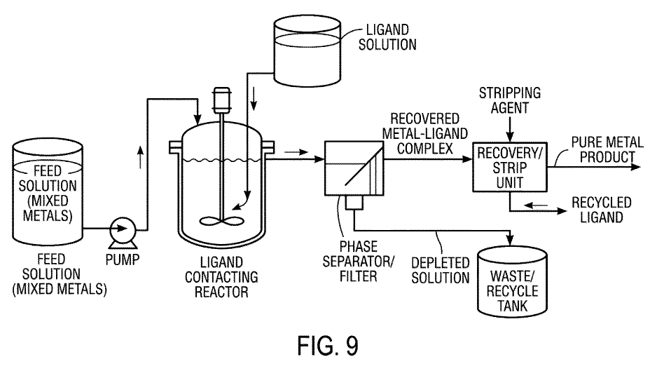

FIG. 10 is a diagram illustrating density-based and optical sorting modules for non-destructive pre-separation of material streams.

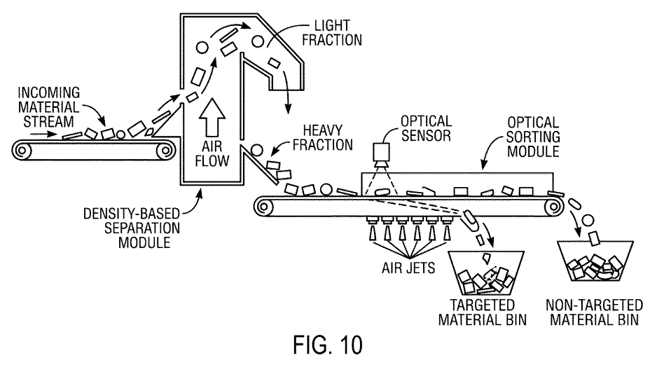

FIG. 11 is a diagram illustrating inline analytical sensing and closed-loop feedback control for purity optimization.

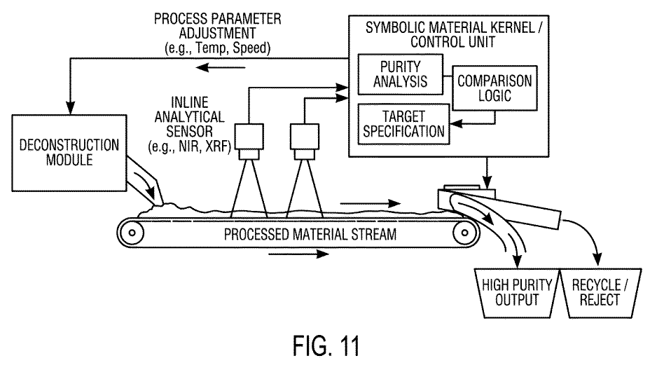

FIG. 12 is a diagram illustrating generation and cryptographic signing of a material provenance record associated with a recovered material batch.

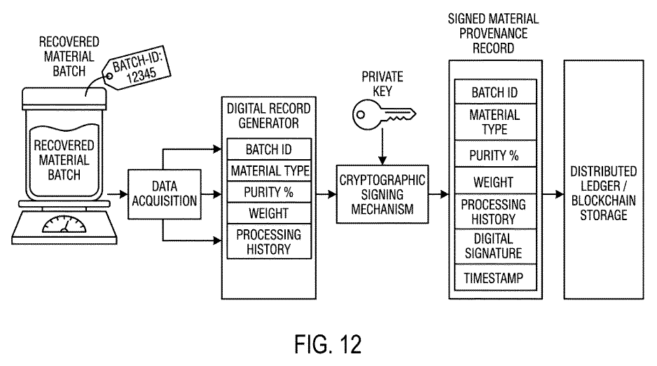

FIG. 13 is a diagram illustrating a distributed or replicated material provenance registry storing immutable processing history logs.

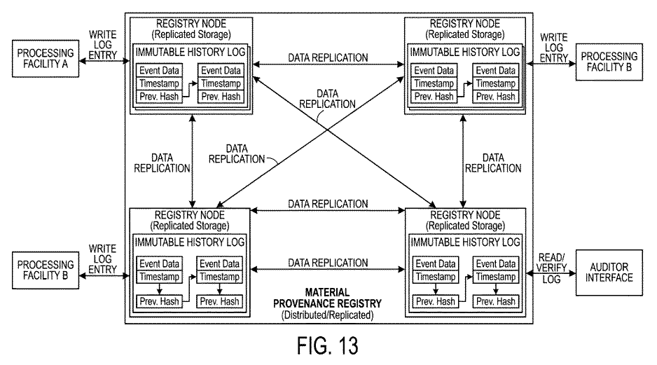

FIG. 14 is a diagram illustrating a sealed negative-pressure processing environment for hazardous materials.

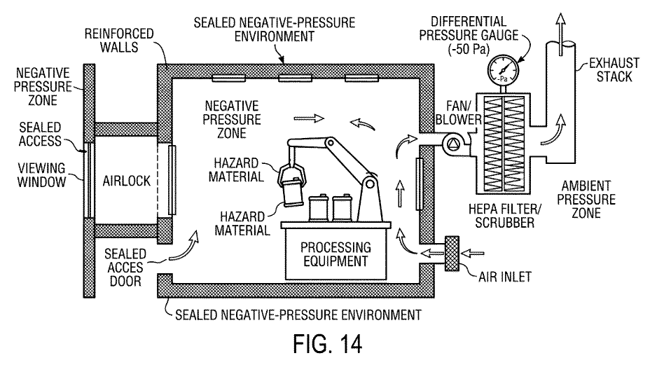

FIG. 15 is a diagram illustrating energy recovery and reuse from thermal or chemical processing stages.

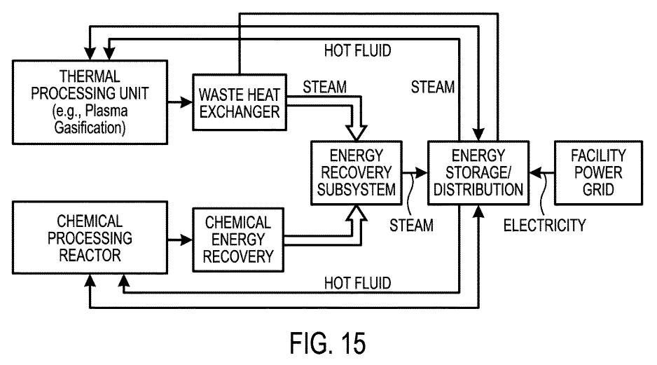

FIG. 16 is a diagram illustrating classification and routing of recovered materials based on compliance and purity attributes.

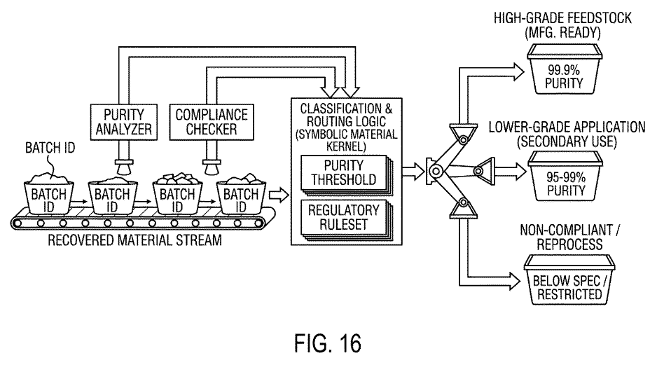

FIG. 17 is a diagram illustrating association of recovered materials with persistent digital identifiers enabling leasing or circular use models.

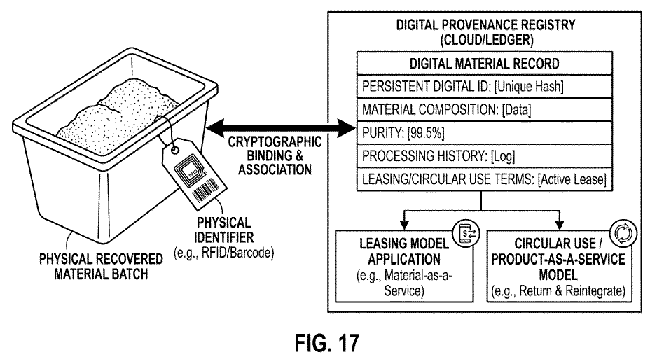

FIG. 18 is a diagram illustrating multi-facility transfer of recovered materials with continuity of provenance records.

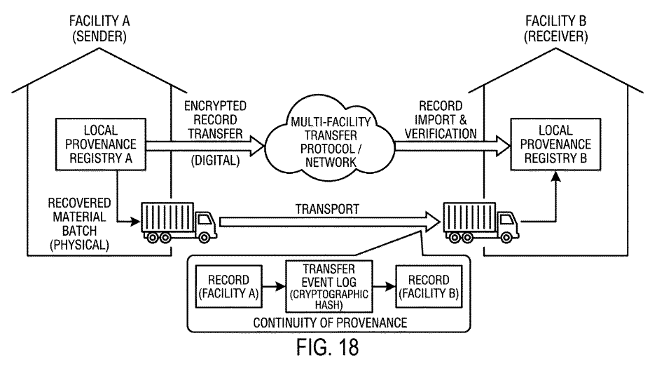

FIG. 19 is a diagram illustrating mass-balance verification and contamination detection across processing stages.

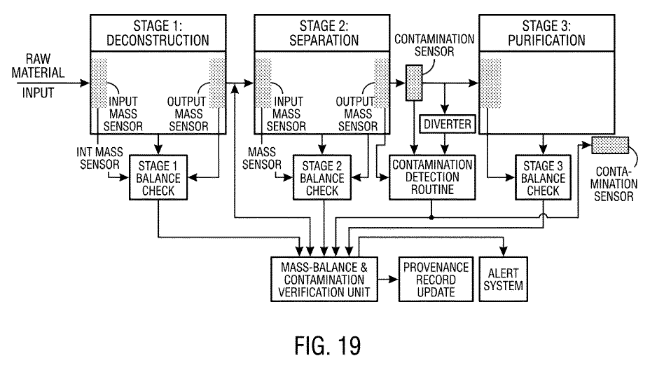

FIG. 20 is a diagram illustrating regulatory compliance evaluation and automated reporting derived from provenance records.

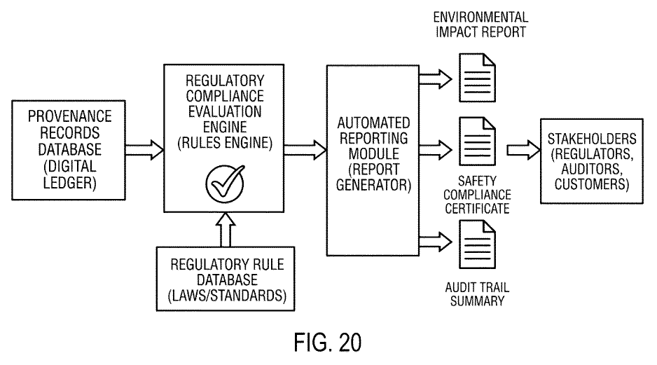

FIG. 21 is a diagram illustrating governance-controlled protocol updates and staged deployment within the recovery facility.

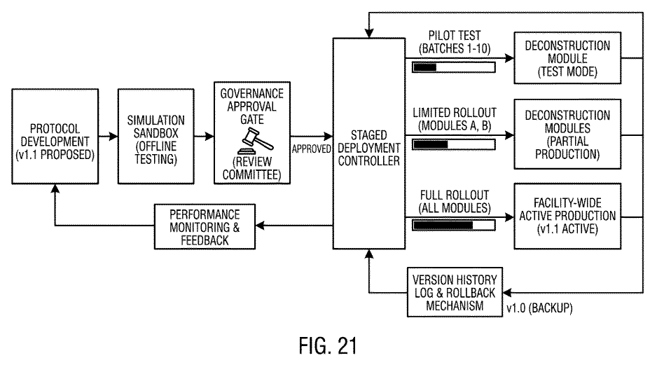

FIG. 22 is a diagram illustrating lifecycle closure, final disposition recording, and generation of a lifecycle completion attestation.

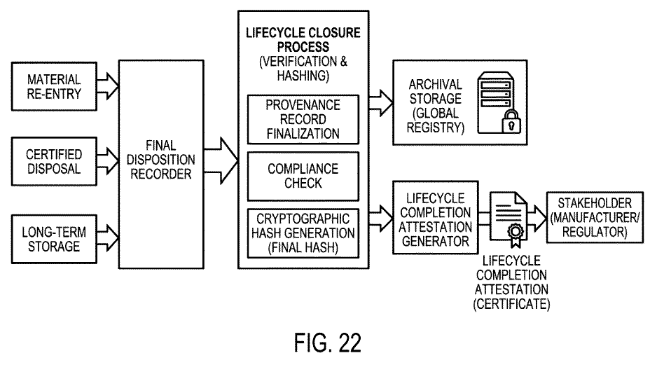

FIG. 23 is a diagram illustrating archival storage and long-term verification of material provenance records.

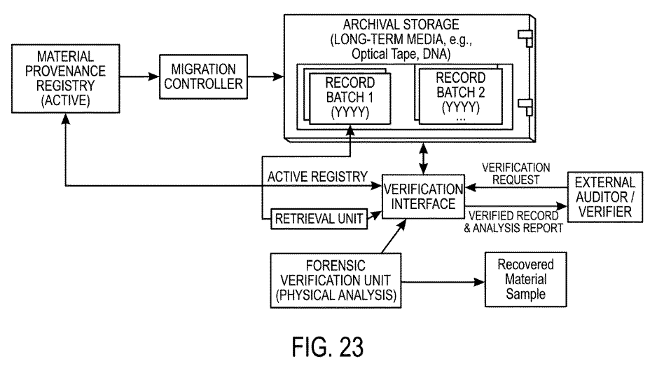

FIG. 24 is a diagram illustrating end-to-end cradle-to-cradle material circulation enabled by the Symbolic Atomic Re-Arrangement Engine.

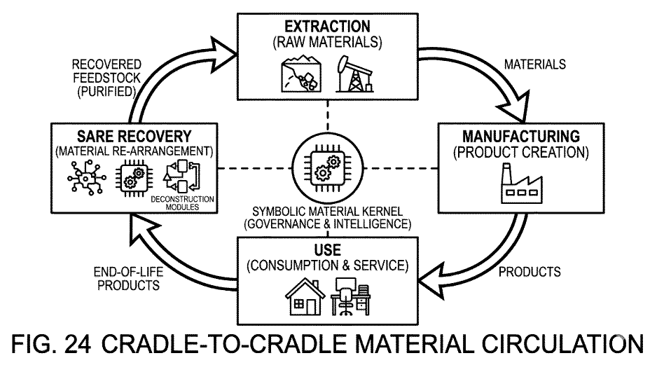

1. A materials recovery and provenance-verified recycling system, comprising:
a. a material deconstruction facility comprising at least one of optical sorting modules, density-based separation modules, electrochemical treatment modules, thermal treatment modules, or biological degradation modules, configured to process composite manufactured products into separated material streams;
a material characterization subsystem configured to generate spectral, chemical, or physical signatures of incoming products or material streams;
a material control kernel comprising one or more processors and non-transitory memory storing executable instructions configured to:
associate the generated material signature with a corresponding stored material composition record;
select a predefined material separation or transformation protocol corresponding to the identified material composition; and
control the deconstruction facility to execute the selected protocol to maximize material purity or recovery yield; and
a material provenance registry interface configured to generate a digital material record for each recovered material batch, the record including at least material type, purity range, and processing history.

2. A method for closed-loop material recovery, comprising:
receiving an end-of-life product or material stream at a recovery facility;
generating a material signature using at least one analytical sensing modality;
matching the material signature to a stored material composition profile;
selecting a material-specific deconstruction protocol based on the profile;
executing the protocol to separate the product into recovered material outputs; and
generating or updating a digital material record associating the recovered material with its processing history and compositional characteristics.

3. A machine-readable material provenance record, stored on a non-transitory medium, comprising:
a unique material batch identifier associated with a physical quantity of recovered material;
a material composition descriptor derived from analytical measurement data;
a processing history log recording one or more transformation or recovery steps applied to the material; and
a compliance attribute indicating suitability of the recovered material for one or more downstream manufacturing applications.

4. The system of claim 1, wherein the deconstruction facility includes a plasma gasification
reactor configured to thermally decompose organic material into synthesis gas and inert residue.

5. The system of claim 1, wherein the deconstruction facility includes enzymatic depolymerization modules configured to convert polymeric materials into monomer feedstocks.

6. The method of claim 2, wherein execution of the deconstruction protocol automatically triggers a machine-executed incentive action based on verified material recovery.

7. The provenance record of claim 3, wherein the processing history log is stored in a cryptographically verifiable distributed data structure.

8. The system of claim 1, wherein the deconstruction facility includes ligand-based separation modules for recovery of rare-earth elements.

9. The system of claim 1, wherein recovered polymer materials are processed to meet food-contact regulatory purity thresholds.

10. The method of claim 2, wherein recovered material outputs are classified as manufacturing-grade feedstock.

11. The system of claim 1, further comprising a water treatment subsystem configured to purify process wastewater to a predefined quality standard.

12. The provenance record of claim 3, wherein the compliance attribute indicates absence of restricted or prohibited material sources.

13. The system of claim 1, wherein the material characterization subsystem includes hyperspectral imaging sensors.

14. The system of claim 1, wherein thermal or chemical energy recovered from processing non-recyclable material is reused to power at least part of the facility.

15. The method of claim 2, applied to electronic waste, wherein precious metals are recovered without bulk combustion.

16. The system of claim 1, applied to textile materials, wherein blended fibers are separated using solvent-based or ionic-liquid processes.

17. The provenance record of claim 3, wherein the processing history log supports carbon footprint computation.

18. The system of claim 1, wherein the deconstruction facility is implemented as a modular containerized unit.

19. The method of claim 2, wherein recovered materials remain associated with a persistent digital identifier enabling function-based product leasing models.

20. The system of claim 1, wherein hazardous materials are processed in a sealed negative-pressure environment.
